(19) United States
(12) Patent Application Publication
(10) Pub. No.: US 2012/0197545 A1
(43) Pub. Date: Aug. 2, 2012

(54) DETERMINATION OF FRACTIONAL COMPOSITIONS USING NONLINEAR SPECTROPHONOMETRY

(76) Inventors: David Burns, Pointe-Claire (CA); Jonathan Dion, Montreal (CA)

(21) Appl. No.: 13/322,489

(22) PCT Filed: May 28, 2010
(86) PCT No.: PCT/CA10/00787

§ 371 Date: Mar. 6, 2012

Related U.S. Application Data
(60) Provisional application No. 61/181,842, filed on May 28, 2009.

(51) Int. Cl. G06F 19/00; G01N 31/00

(52) U.S. Cl. 702/27; 702/104

(57) ABSTRACT

Applicants have discovered new methods and apparatuses for determining the fractional composition of a component in a multi-component mixture using multivariate statistical analysis of the ultrasonic frequency profile. Applicants show the use of ultrasonic spectrophonometry to determine the fractional composition of a component in a 3-component solvent mixture comprising water, ethanol and methanol as well as determination of the fractional composition of certain contaminants in water. Applicants provide a method of determining a fractional composition of a component in a multi-component mixture comprising pulsing a mixture with a source of ultrasounds, detecting “non-linear” ultrasonic spectral data propagating through the mixture and computing the fractional composition of the component.

### FIELD

The present invention relates generally to determining fractional compositions in multi-component mixtures using ultrasonic spectrophonometry. The present invention further related to the identification of samples composed of varying fractions of solvents using multivariate linear regression analysis of the ultrasonic spectral profile propagating though the media.

### BACKGROUND

Ultrasounds have been used as a diagnostic medical imaging technique for more than 50 years. This is done using the echo of an ultrasound pulse and the echo strength of the pulse to construct an image. The technology is relatively inexpensive and portable. Other well known non-destructive applications of ultrasound are the detection of defects. All acoustic phenomena involve the vibration of particles of a medium moving back and forth.

Human hearing range is typically in the frequency range 20 Hz-20 kHz. Ultrasound is classified as a sound wave with a frequency greater than 20 kHz. Diagnostic medical imaging uses frequencies between 1-10 MHz. The ultrasound wave is non-ionizing radiation which is a mechanical wave and does not have properties like an electromagnetic wave.

Process chemistry relates directly to the analysis of chemical reactions. Information about chemical kinetics and the progress of chemical reactions allow greater control over final products. Process control is a crucial step in the manufacture a wide variety of products including foods, industrial products, and biomedical compounds. Minor deviations in the balance between any number of constituents can lead to failed batches. Due to the sensitivity of many reactions, on-line or at-line measurement is appealing due to the immediacy of the results that allow timely optimization.

The characterization of solution compositions is important in a large number of industrial processes. Currently, ultrasound technology is used in the assessment of various commercial products. The process involves ultrasonic velocity measurements at a series of temperatures to determine compositions.

Ultrasound-based determination of a component in a multi-component mixture can be made by measuring the velocity of the ultrasound as it traverses the medium. Velocity of ultrasonic waves is dependent on the visco-elastic properties including the specific gravity and the compressibility. Less elastic media will result in a quicker propagation speed. For example, the velocity of ultrasound in ice water is approximately 3900 m/s, as compared to 1400 m/s in liquid water (˜25° C.). Velocity measurements have been used to characterise multi-component systems (Vatandas, M, Koc A B, Koc C, 2007, Eur Food Res Technol (2007) 225:525-532, Ultrasonic velocity measurements in ethanol-water and methanol-water mixtures). However, these measurements provide a singular velocity measure, and so, lack quantification power for more than one chemical.

For example, the fermentation of alcoholic beverages is highly regulated for both commercial quality and for health and safety purposes. Ethanol evolution through fermentation is desirable, but methanol by-product is a health hazard and is regulated in many countries. Likewise, ratios of sugars to water and alcohol concentrations are extremely important in the brewing process to ensure the production of reproducible and characteristic products. Nonlinear propagation in solvents occurs due to physical properties of the media. Due to the inability of the medium to expand and contract in a complete manner, propagating ultrasonic waves are distorted. A complete treatment can be found in Torres and Walsh, Journal of Computational Acoustics, Vol. 15, No. 3, 353-375, 2007.

Applicants have previously discovered in a co-pending application (Pub. No. WO/2010/015073) that ultrasonic spectrophonometry can be used to determine pH based on pH-dependent conformational changes of albumin and red blood cells using multivariate analysis of the spectral data resulting from an ultrasonic pulse. In that application, ultrasounds were used to detect the conformational change of a relatively large component of a mixture such as albumin or red blood cells.

Vatandas et al, teach that velocity measurements can be made at different temperatures in order to determine the identity of three or more components (solvents) using an ultrasound approach. In this reference, a temperature ramping program has been successfully applied to the determination of 3-component alcohol mixtures. However, the need for multiple measurements increases the time required for the quantification. Likewise, this also greatly increases the complexity of the instrument required, and in some cases, it is not possible to alter process temperature. If in-line (or real-time) measurements are required, heating a test sample to various different temperatures in order to measure ultrasound propagation speed though the sample is not ideal.

Due to the drawbacks of the prior art references, it is desirable to provide a method and apparatus for determining the fractional composition of a component in a multi-component mixture without the need for varying temperature and even when the mixture is composed of two or more fluids/solvents. Such a method and apparatus should allow real-time determinations, be easy to use and inexpensive to manufacture.

### SUMMARY

Applicants have discovered new methods and apparatuses for the determination of the composition of a mixture containing two or more components using multivariate statistical analysis of the ultrasonic frequency profile. Applicants show the use of ultrasonic spectrophonometry to distinguish between water, methanol and ethanol. Applicants also show the use of ultrasonic spectrophonometry to detect and quantify certain water contaminants. Transmission ultrasound measurements were made in the 0.5-10 MHz frequency range.

The frequency dependence of the ultrasonic transmissions was characterized for the solvents at varying concentrations in mixtures. Distinct spectral differences were found between the different solvents that can be used for the determination of fractional composition in two component mixtures. Likewise, to examine the potential of exploiting these spectral changes in more complex analyses, stagewise multilinear regression was used. Over limited concentrations ranges (0-35% for methanol, 0-35% for ethanol, and 1-100% for water) a calibration was possible using a selected number of frequencies with an R² greater than 0.93 and a SEECV less than 3% composition. Overall, these results show determination of the fractional composition of multi-component mixtures or solvents. In addition, ultrasonic spectroscopy is well suited towards analyte monitoring across scattering layers and boundaries. The results show a strong potential for application in research, healthcare and industrial settings.

It is therefore an object of the present invention to provide a method of determining a fractional composition of a component in a multi-component mixture using multi-linear regression analysis of the ultrasonic spectral profile propagating through the mixture.

Applicants have found that the fundamental physical properties of chemicals such as their non-linear reaction to high-frequency oscillating pressure fields allow for determining a fractional composition of a component in a multi-component mixture by pulsing the mixture with a source of ultrasounds, detecting ultrasonic spectral data propagating through the mixture and computing the fractional composition of the component wherein such non-linear properties result from hydrogen bonding between components of a multi-component mixture.

The statistical approach comprises using step-wise multi-linear regression to establish a relationship between spectral frequency data and fractional composition of the component wherein the statistical analysis identifies two or more frequencies selected to reduce an error in fractional composition estimation when using the frequencies for calculating fractional composition. A Fourier transform of the time domain can be used to compute a spectral profile of intensity and frequency prior to statistical analysis.

Is some embodiments of the present invention, the ultrasonic probing consists of a pulsing ultrasound frequency of approximately 5 MHz and the spectral profile is collected for a frequency range between 0.5 and 10 MHz.

It is an object of the present invention to provide a method and apparatus for fractional determination of mixtures comprising two components, three components. It will be appreciated by those skilled in the art that the mixture can contain any number of components as long as the spectral profile allows for establishing relationships between mixtures of different fractional composition.

In some embodiments of the present invention, the component is water, ethanol or methanol and the quantification of the component can be important, for example, in the brewing industry.

In another embodiment of the present invention, the mixture is essentially water, and the component can be a water contaminant such as soil, nitrates, urine, sodium sulphates, potassium phosphate and glycerine. Such a fractional determination of mixtures and components would find practical use in the water treatment and wastewater industries, for example.

It is another object of the present invention to provide an ultrasound detector for detecting components in mixtures which would signal (to an operator for example) when a predetermined concentration of contaminant is reached. This useful in the water industry where specific thresholds exist for certain contaminants. Indeed, the water purification industry has strict limits and thresholds to ensure high quality drinking water free of contaminants whereas the wastewater industry has thresholds for water discharge into rivers and other waterways. An important advantage of using ultrasound according to present invention is that determinations can be done in real-time or on-line.

In yet other embodiments of the present invention, there is an added step of step of securing an ultrasound apparatus of the present invention to one side of a scattering boundary for determining the fractional composition of a mixture on another side of the scattering boundary. It will be appreciated that a scattering boundary is any boundary which scatters ultrasounds more than the mixture of components which is being probed such as human tissue or a fluid conduit wall. In one specific example, the scattering boundary is skin, the mixture is blood and the component is glucose. This combination would thereby allow for the non-invasive determination of blood glucose in humans by securing an ultrasound device of the present invention to a body part having underlying blood vessels. Similarly, any body fluid which can be probed by ultrasounds and detected could allow for fractional composition determinations of components in blood, cerebral-spinal fluid, cell culture media and amniotic fluid.

It is yet another object of the present invention to provide a method of calibrating an ultrasound device for determining a fractional composition of a component in a multi-component mixture comprising: The calibration can consist of probing a reference fluid with an ultrasound pulse or a series of scanned frequencies, detecting ultrasonic spectral data resulting from the pulse, repeating the steps of probing and detecting using reference fluids of different fractional compositions of the component, identifying frequencies at which signal intensity varies with fractional composition of the fluid component and adjusting the device to detect at least those frequencies.

It is yet another object of the present invention to provide an apparatus for determining a fractional composition of a component in a multi-component mixture using ultrasounds, wherein the apparatus is configured to perform the method of the present invention. Such an apparatus comprises an ultrasonic transducer for generating and detecting an ultrasonic pulse, a pulse generator for sending an input signal to the transducer, a detector circuit connected to the transducer for providing an output signal, and a processor for determining a fractional composition value using the output signal.

In some embodiments of the apparatus, a securing mechanism is used for securing ultrasound instrumentation to the outside of a conduit. The securing mechanism can be a clip-on system, a screw-based fastener, a magnet, a biasing system, a tie-wrap or any other suitable securing means, as long as the apparatus is securely secured.

In some embodiments of the apparatus, a detector circuit can be provided with narrow band frequency filters and the ultrasounds can be generated and collected with a piezoelectric crystal transducer. In yet other embodiments of the apparatus all parts are located inside a portable hand held device for ease of use in the industrial and healthcare fields. Such a portable device would be especially useful for taking various measurements along piping systems (aqueducts) or as a take home device for monitoring blood glucose in diabetics.

### BRIEF DESCRIPTION OF THE DRAWINGS

Having thus generally described the nature of the invention, reference will now be made to the accompanying drawings, showing by way of illustration, an embodiment or embodiments thereof, and in which:

FIG. 1 illustrates known forms of intermolecular hydrogen bonding in water, methanol, and ethanol, highlighting that compressibility can be used to monitor hydrogen bonding.

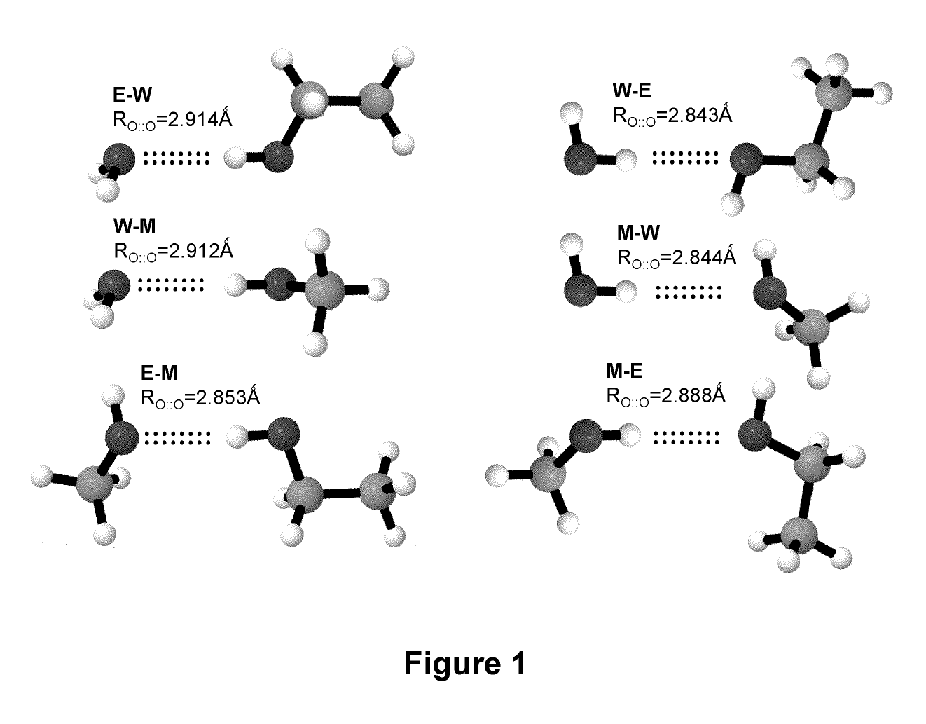

FIG. 2A is a schematic representation of how ultrasound waves propagate nonlinearly in water. FIG. 2B shows the spectral broadening (dark line) from propagation of a narrow frequency band pulse (thin line) in a media due to non-linear distortion;

FIG. 3 shows a schematic representation of the ultrasound spectrophonometric system including some elements that can be used for determination of fractional composition of a component in a multi-component mixture.

FIG. 4 depicts the ultrasonic frequency spectra of pure water (dashed line), methanol (solid line), and ethanol (dotted line).

FIG. 5 shows the frequency exchange from 100% water to methanol (a) or 100% ethanol to methanol (b), thus highlighting the ultrasonic changes in 2-component mixtures.

FIG. 6 shows the known volume fraction correlated with the value estimated by the multi-linear model in 2-component mixtures. (A) methanol-water mixture, (B) ethanol-water mixture, (C) methanol-ethanol mixture.

FIG. 7 shows the known volume fraction correlated with the value estimated by the multi-linear model in 3-component mixtures. (A) Water Fraction, (B) Methanol Fraction, (C) Ethanol Fraction.

FIG. 8 shows the relationship between ultrasound propagation velocity and the volume fraction of water in methanol (•) and in ethanol (+).

FIG. 9 shows known volume fraction correlated with the value estimated by the multi-linear model in 3-component mixtures over a focused volume fraction range. (A) Methanol Fraction, (B) Ethanol Fraction.

FIG. 10 shows the determination of ethanol fraction in water/glucose (3-component mixtures) tested with 2 alcoholic beverages of known fractional compositions.

FIG. 11 shows a graphic with low (inside dotted circle) and high (outside dotted circle) concentrations of various water contaminants plotted as a function of 2 principal component scores.

FIG. 12 shows the discriminatory capacity of using two “principal component” frequencies for several contaminant concentrations.

FIG. 13 is a schematic illustration of a portable instrument for the ultrasonic determination of fractional compositions in multi-component mixtures. A scattering boundary such as a conduit or tissue is depicted as a dashed line.

FIG. 14 illustrates one embodiment of industrial ultrasound instrumentation for determination of fractional composition in multi-component mixtures using a reference sample. The system is adapted for inserting into a waterline or conduit using valves.

FIG. 15 shows a device for same side ultrasonic measurements such as Waveguide Measurements.

### DETAILED DESCRIPTION

Ultrasonic spectroscopy has emerged as a technique that monitors the attenuation rather than velocity of ultrasonic waves. Oscillating compression and rarefaction wave phases cause the vibration of intra- and inter-molecular bonds. The contribution of the molecular vibrations to the attenuation is related to the volume fraction of the molecular species. This technique has been applied to the monitoring of processes such as polymer formation and enzymatic reactions, and for particle sizing of colloids and particulates. However, few investigations have been carried out on the medium itself rather than suspended particles.

The viscoelastic properties of liquid media affect not only the ultrasonic velocity, but also the frequency content of propagation waves. Ultrasound waves are known to propagate nonlinearly because the alternating compression and rarefaction phases travel at different velocities. The result of this nonlinear propagation is the generation of new frequencies as energy is transferred to harmonic frequencies. The nonlinear qualities of liquids have been described according to a second order elastic nonlinearity ratio B/A defined as:

$$\frac{B}{A} = \frac{{ρ}_{0}}{{c}^{2}} ( \frac{{\partial }^{2} P}{\partial {ρ}^{2}} )$$

where ρ₀ is the mass density at ambient conditions, c is the speed of the ultrasonic wave, P is the pressure. This nonlinear parameter is characteristic of a given medium. For example, B/A in water is 5.0, while in methanol it is 9.42, and 10.52 in ethanol. It has also been shown that mixtures of two liquids have a B/A value that is altered from either pure liquid and which varies nonlinearly.

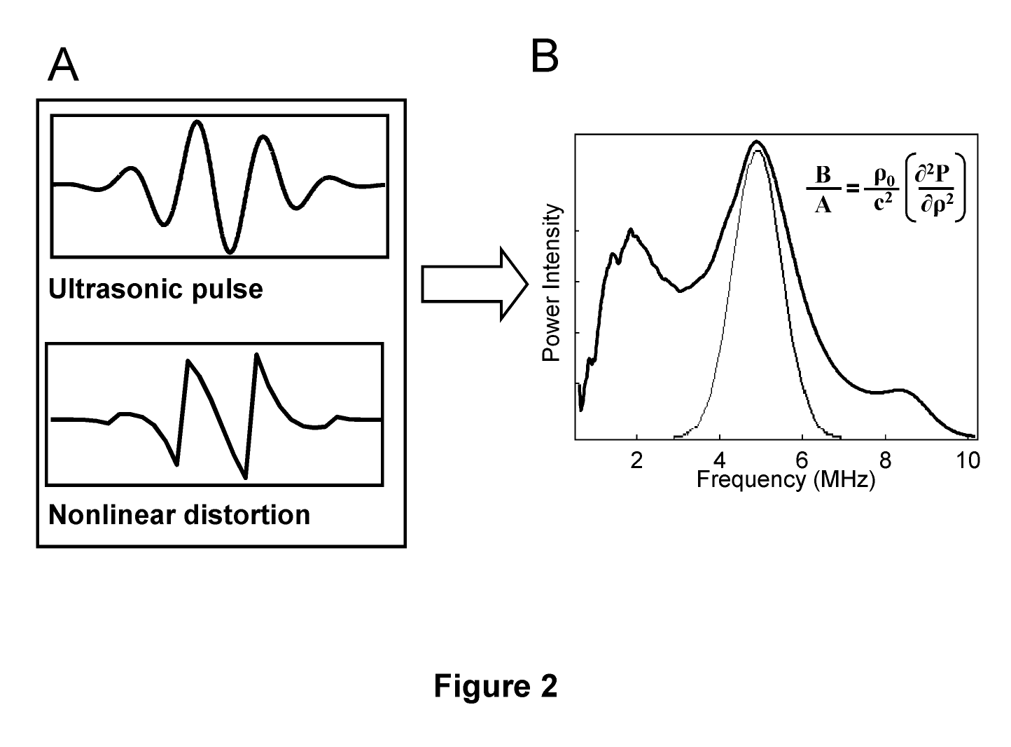

Applicants present herein a spectroscopic analysis of liquid solutions based on ultrasonic frequency analysis. While wavelength coverage in traditional spectroscopic applications is limited, ultrasound frequency bandwidths are easily modified electronically. By monitoring a larger range of ultrasonic frequencies, simultaneous quantification of several components is possible. Though the specific frequency change may not be linear, multivariate analysis of the results should allow analytical quantification. FIG. 2 is a schematic representation of how uultrasound waves propagate nonlinearly in water and the spectral broadening from propagation of a narrow frequency band pulse in a media due to non-linear distortion;

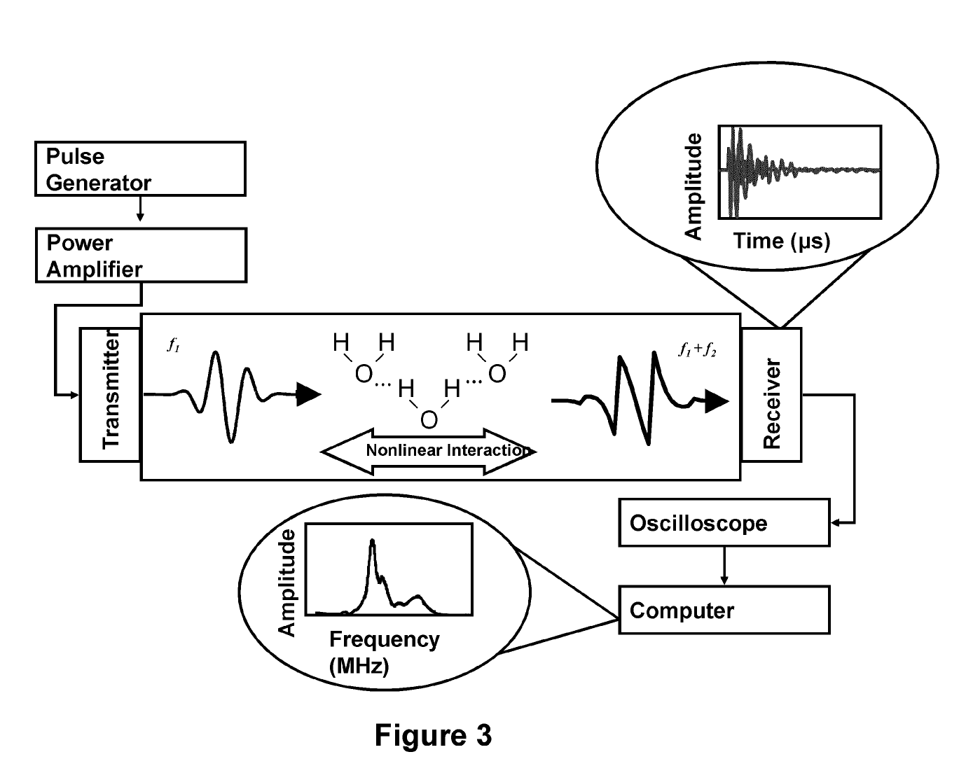

Two transducers with pulsing frequencies of 5 MHz were set up such that they sandwich the sample cell. The two transducers shown are for illustrative purposes because the source and receiving transducers can be the same transducer. A piezoelectric transducer (Russell NDE Systems Inc., Edmonton, Alberta, Canada) is used in the preferred embodiment. The source or probing or pulse transducer is understood as meaning the device which converts electrical energy into ultrasound energy for propagating through a fluid. Also, it will be appreciated by those skilled in the art that the spectrophonometry instrument shown in FIG. 3 is used in a research setting for calibrating and determining optimal frequencies and spectral data for unknown fluid, mixtures and components. In such cases, it can be important to have reference solutions for establishing correlations between frequency and fractional composition.

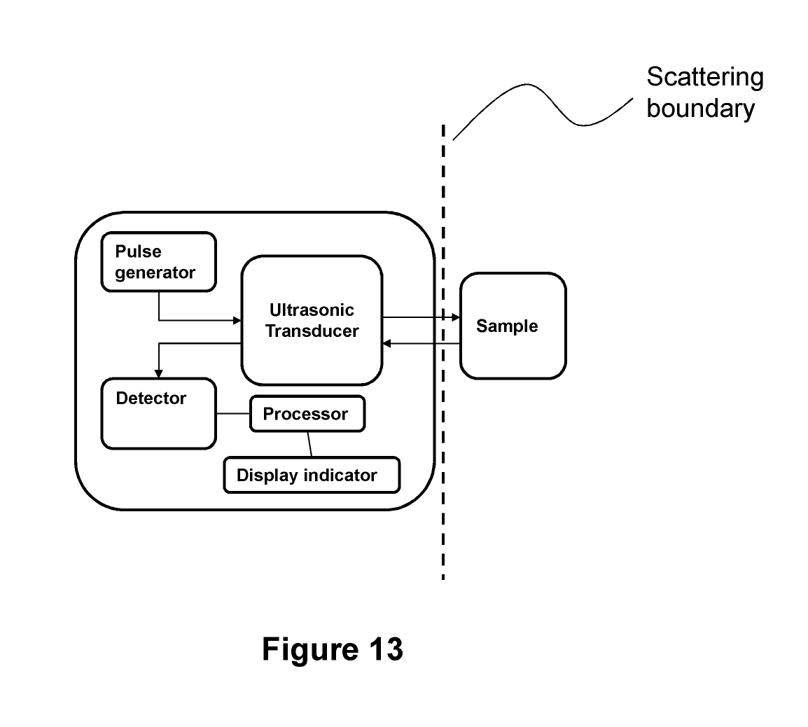

It will be appreciated that, in a device for industrial or healthcare applications, some elements may not required. Indeed, all calculations can be performed by an electronic circuit or processor that can replace a computer (as shown in FIG. 13), the electronic circuit or processor being designed to use predetermined frequencies at which fractional composition correlates with signal intensity. The calculations can add weighted responses at different frequencies according to a multiple linear regression equation developed. Calculations can be electronically or digitally performed. Furthermore, oscilloscopes are not required if the apparatus is preconfigured for industrial or healthcare purposes.

All components of such ultrasound instrumentation can be designed to fit in a self-contained handheld apparatus for use in water quality determinations and in the healthcare industry such as hospitals, clinics, emergency rooms, ambulances, etc. Specific narrow band filters can be used to capture only these specific predetermined frequencies, or, alternatively, spectral data can be captured and specific frequencies can be obtained from the spectral data. In the latter case, a Fourier transform can be performed to obtain a spectral data plot of intensity as a function of frequency.

Deionized water used in the experiments was purified using a Millipore (Billerica, Mass.) Milli-Q OM-154 water purification system, which was used for all experiments. Ethanol and methanol were obtained from Sigma-Aldrich (Oakville, ON). Ultrasonic spectra were collected at room temperature ranging between 21° C. and 22° C.

Ultrasonic spectrophonometry measurements were made using a custom-built transmissions-mode configuration schematically depicted in FIG. 3. An ultrasonic Transmitter/Receiver (500PR Panametrics Inc.) was used to generate short (<20 ns) electrical pulses to drive an ultrasound transducer. A repetition rate of 1 KHz was used to ensure sufficient time for the ultrasonic wave to decay. Decay time is important to prevent the formation of a standing wave in the cell, which would lead to signal distortion. The electric pulse was transmitted into a first transducer, which converted this to an ultrasonic pulse. The ultrasonic pulse was transmitted across a custom Plexiglas® cells with a 1.5 cm pathlength. In order to minimize reflections across interfaces, 60 μM polyacetate windows were used. This window material did not significantly attenuate the ultrasound transmission. The ultrasonic transducers were coupled to the acetate windows using petroleum jelly to ensure minimal loss of the ultrasound wave due to coupling. A second ultrasonic transducer on the opposite side of the sample cell received the ultrasonic wave, which were digitized using a computer controlled oscilloscope (Handyscope HS3, TiePie Engineering) sampling at 50 MHz with a 12 bit dynamic range. Frequencies between 0.1 and 10 MHz were retained and processed.

Two pairs of transmitting and receiving transducers were used in the experiments outlined below in order to examine the frequency dependence of the resonant effect. The first configuration consisted of a 1.9 MHz transducer (Phillips Medical Systems) generating ultrasonic pulses and a 5.0 MHz (Technisonic) receiving transmitted pulses. Both of these transducers had cross-sections of approximately 13 mm. In the second configuration, the pulsing and receiving transducers used were 5.0 MHz probes from Technisonic. These transducers had 6 mm cross-sections. Ultrasonic waves will freely travel through both a liquid sample and a cell wall therefore care must be taken to ensure that the waves are guided through the sample and not the surrounding material. This was ensured by matching the cell width to the transducer diameter. Additionally, a series of baffles were machined into the cell to minimize scattered ultrasonic waves.

Analytical processing of ultrasound data consists of three primary steps: phase matching, frequency transformation, and modelling. The velocity of ultrasonic waves is highly dependent on the medium of propagation. Small changes in the fractional composition or in the temperature of the sample result in a phase difference, which will move the waveform out of the analysis temporal window. In order to compensate for the phase changes, each ultrasonic measurement was aligned at the highest intensity peak in the waveform.

The nonlinear propagation of the ultrasonic wave is dependent on the fractional composition of the samples. Changes to the fractional composition result in a convolution across the signal in the time domain. A fast Fourier transform algorithm was used to compute the frequency spectrum of the ultrasonic waveform. By the convolution theorem, a convolution in the time domain can be expressed as a multiplication in the frequency domain, which can be modeled through a series of linear equations. Frequencies in the spectra between 0.1 MHz and 10 MHz were retained for multi-linear analysis.

Ultrasonic frequency spectra were divided into independent calibration (⅔ of the total data) and test sets (⅓ of the total data). The calibration data were used to develop a multilinear model for the fractional composition of each sample. This model was then used to predict the concentrations of independent spectra in the test data set. Stagewise multi-linear regression (MLR) was used to determine the linear combination of a subset of frequencies to best describe the data in the form

Y=b₀+b₁X₁+b₂X₂+ . . . +bₙXₙ (2)

where Y is the dependant variable (here the alcohol concentration), {X} are independent variables (the intensity at a given ultrasound frequency), and {b} are the weighting coefficients determined. The most parsimonious model was selected using an F-test (α=0.05) between calibrations. Details of the MLR model selection are provided in Arakaki et al (Arakaki, L; Burns, DH; Kushmerick, M* Accurate Myoglobin Oxygen Saturation by Optical, Spectroscopy Measured in Blood-Perfused Rat Muscle, Applied Spectroscopy, 61(9), 978-985, 2007). Effectiveness of each model is tested by calculating the correlation coefficient and standard error. The MLR routine was written in Matlab (The MathWorks Inc., 2008a).

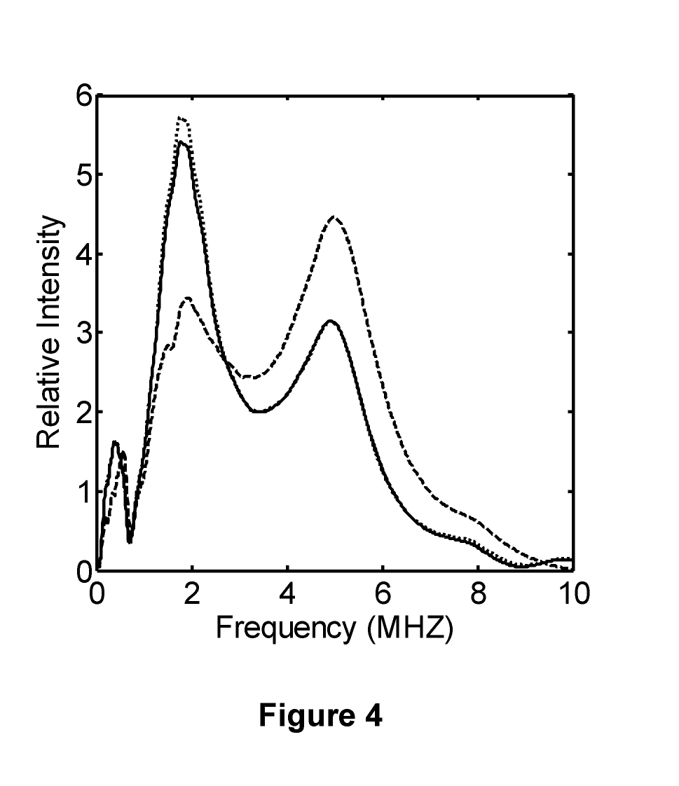

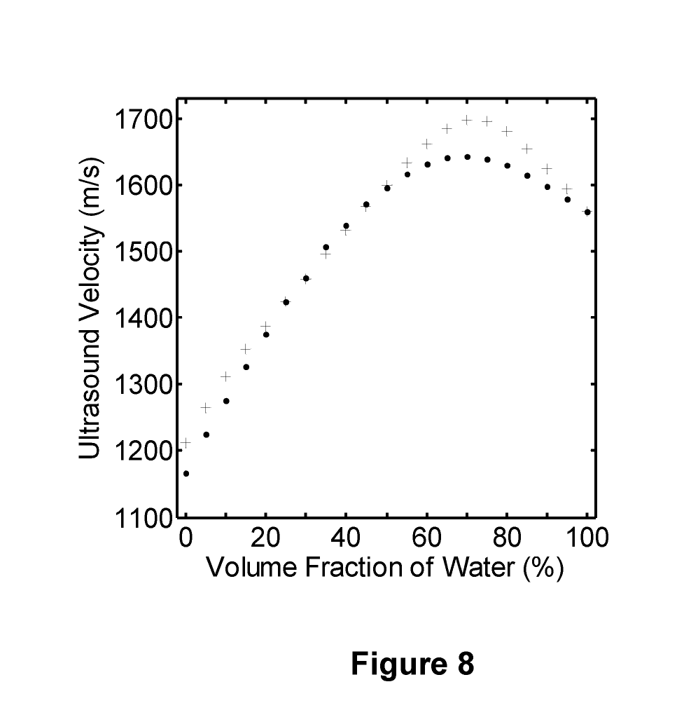

Measurement of binary mixtures. To determine what frequency differences arose from the different nonlinear behaviours in the three liquids, ultrasonic frequency profiles of water, methanol, and ethanol were measured. Characteristic differences are apparent between the spectra of these pure solvents. As illustrated in FIG. 4, the spectral profile of methanol and ethanol both show higher intensity at 2 MHz than at the 5 MHz center frequency. While the difference between the methanol and ethanol profiles is small, the spectrum of water is significantly different, with the peak intensity at 5 MHz appearing more prominently. In order to characterise the ultrasonic response in two-component systems, binary liquid combinations were examined. Water/methanol (W/M), water/ethanol (W/E), and methanol/ethanol (M/E) binary mixtures were prepared. The fractional composition of each solvent was varied between 0% and 100% v/v of the total mixture volume. Although the velocity of ultrasound propagating through each liquid is well characterized, estimating the volume fraction in non-pure samples is challenging. FIG. 8 illustrates the velocity of ultrasound through mixtures of water and ethanol. This diagram shows that the velocity reaches a maximum value at approximately 35% water. Consequently, determining the volume fraction between 0% and 50% water is not possible due to the overlap in measured velocities. Measurements at multiple temperatures would cover the range of water fractions, however, this process requires sensitive temperature regulation, and is time consuming.

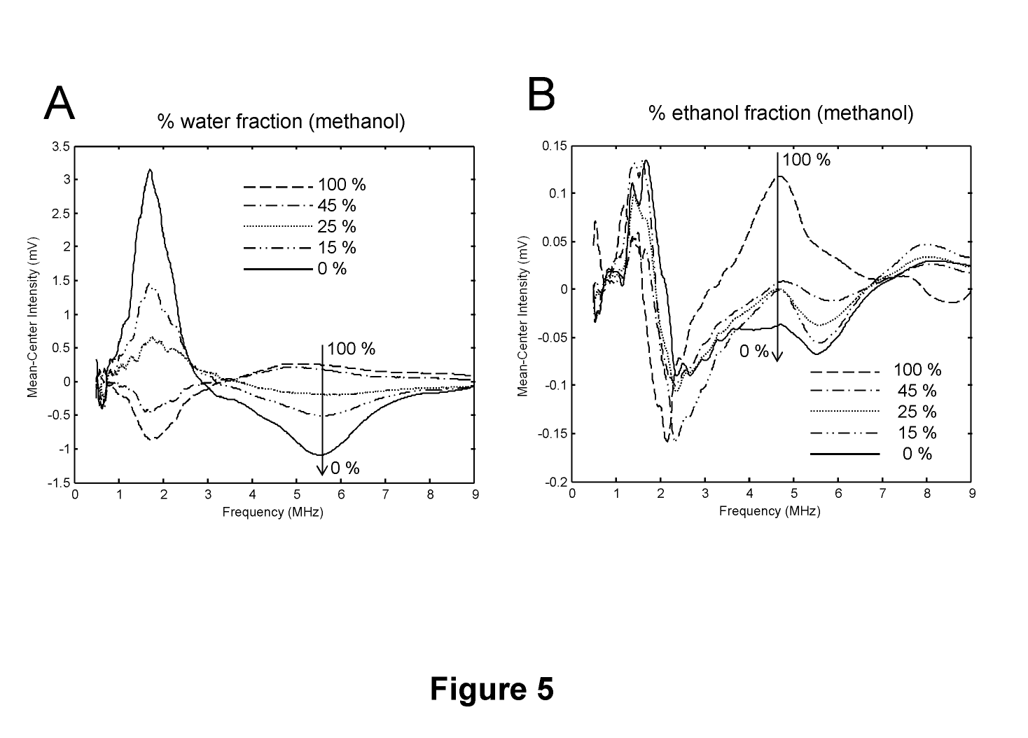

Binary mixtures were analyzed using the ultrasound frequency analysis technique. FIG. 5(a) illustrates the frequency exchange that is seen in W/E mixtures. The mean spectral profile was subtracted from spectra at 0, 15, 25, 45 and 100% volume fractions. There is a decrease in intensity of frequencies in the 1-3 MHz range. Likewise, frequencies between 3-9 MHz show a simultaneous increase. A similar exchange in frequencies is present in the W/M series and is illustrated in FIG. 5(b). The frequency exchange illustrated in the two-component mixtures demonstrates nonlinear characteristic similar to those in velocity measurements. In both W/M and W/E, the intensity of the frequencies between 1-3 MHz decrease as the water fraction increases. However, at approximately 35% water content, the trend is reversed, and the intensity of these frequencies starts to increase again. This is consistent with the known changes to the viscoelastic properties that result in the velocity apex at the same water fraction.

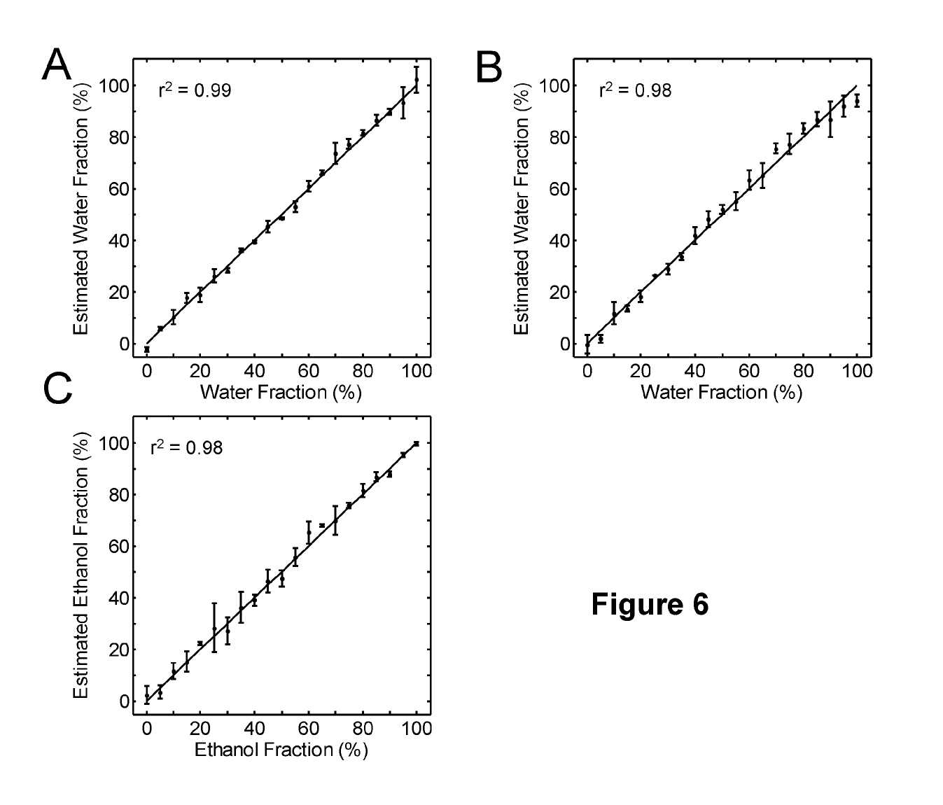

To quantify the fractional composition of each component in these mixtures, the SMLR procedure was applied to the frequency data. Multilinear regression analysis revealed a close correlation between the intensity of certain ultrasonic frequencies and the fractional composition of each mixture. The volume fraction of water in W/M and W/E mixtures and methanol in M/E was estimated. Because of the closure in these systems, the second component can be solved by subtracting the estimated fraction from the total volume. The correlation coefficients and standard errors for the estimation of volume fraction are shown in table 1. The estimated volume fractions are presented in FIG. 6 (a-c) and illustrate that volume fraction of water, methanol, and ethanol in can be determined over the full range (0% to 100%). While the ultrasound velocity bias in the frequency domain is present, the efficacy of the multilinear model illustrates that spectral profile of a liquid is linked to the viscoelastic properties.

TABLE 1
Figures of merit for the determination of fractional components in binary
mixtures

| | Correlation | | |
|---|---|---|---|
| Mixture | Coef (r²) | Standard error (%) | Frequencies (MHz) |
| W/M | 0.99 | 3.0 | 6.92, 1.90, 4.64, 9.30 |
| W/E | 0.98 | 4.2 | 5.86, 9.44, 3.38, 4.23 |
| E/M | 0.98 | 3.9 | 3.23, 9.86, 0.77, 0.83 |

### Measurement of 3-Component Mixtures.

In order to study the effect of a third component, three-component (ternary) mixtures of water, methanol, and ethanol were prepared. The three liquids were varied between 10 and 80% of the total volume in a series of combinations at 10% intervals.

Ultrasonic frequency spectra of the 3-component mixtures show similar characteristics as the 2-component data. The dominant effect with the increase of methanol and/or ethanol is a large frequency exchange between the regions of 1-3 MHz and 3-9 MHz. This is consistent with the result seen in 2-component mixtures above. Likewise, as in the 2-component mixtures, the frequency exchange reaches a maximum intensity when the water fraction represents approximately 35% of the total volume.

Based on the observed changes in the frequency spectra, a multi-linear calibration model was developed. Initial results demonstrated a less efficient modeling of the volume fractions based on the ultrasonic intensity (r²<0.75) for all three liquids. It is hypothesized that the multi-linear regression analysis accounts for mixture components in the solutions, rather than only the pure components. The hydrogen bond lengths (D) vary widely between homodimers and heterodimers (see table 2) (Canuto et al, Chem Phys Let., 2004, 400, 494-499). For example, D_{H2O-H2O}=2.918 Å and D_{MeOH-MeOH}=2.846 Å, however D_{H2O-MeOH}=2.912 Å. Likewise, bond energies vary further due to the amphoteric nature of the three liquids. If methanol is electron donor in the previous example, D_{MeOH-H2O}=2.844 Å. Due to the heterogeneous nature of the liquid mixtures, it is likely that heterodimers contribute strongly to the frequency profile.

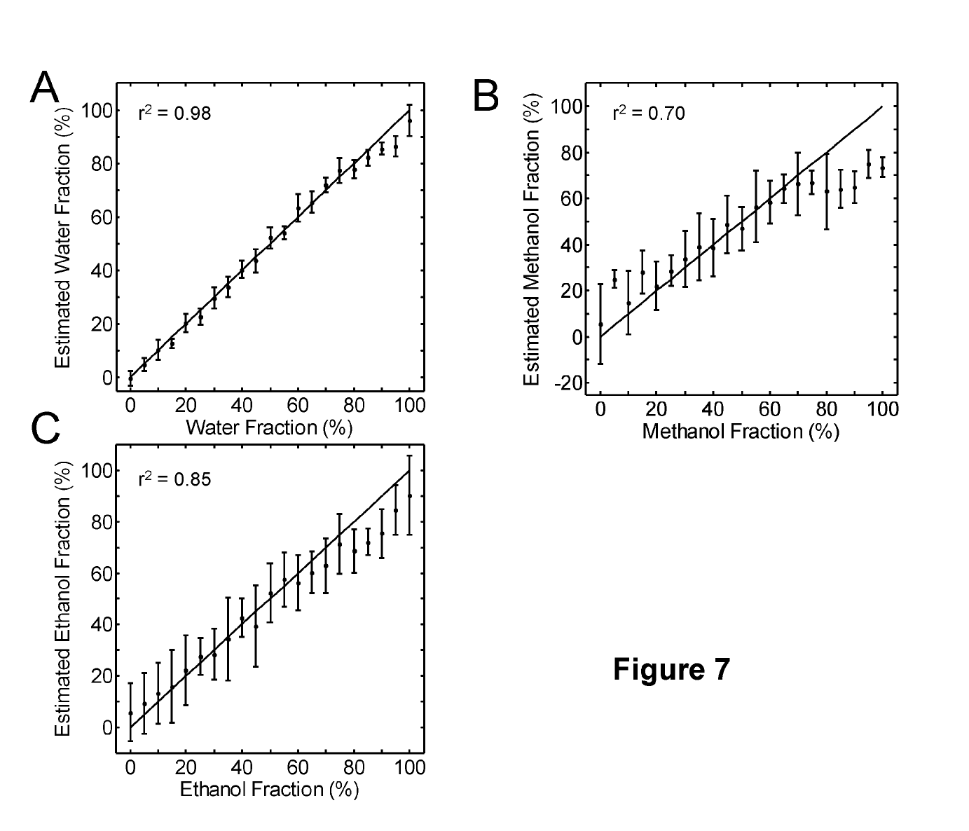

Assuming that the 3-component mixture data set lacks information on binary mixture structures, the 2-component data were included for multilinear modelling. A new multilinear analysis was performed, and this model was tested on an independent evaluation set to estimate the volume fraction of each liquid in the combined two and three-component mixtures. Analysis demonstrated a close correlation between the intensity of 6 ultrasonic frequencies and the volume fraction of water (r²=0.98 SEE=3.8%). Estimates of water percentage in the samples relative to the known values are shown in FIG. 7. This figure illustrates that results are linear over the full range (0-100%) of water fractions.

Multi-linear regression analysis was also used to generate independent models for the methanol and ethanol volume fractions. Estimates of these two components were less accurate than those of water. Methanol volumes had a standard error of 16.2% (r²=0.70) and the standard error in ethanol volume estimation was 11.5% (r²=0.85). The lower correlation of the data to the model for methanol and ethanol suggests that the greater similarity in the viscoelastic properties of these liquids may be a quantitative confound. This can be explained by the specific intermolecular forces that are present in each liquid system. Hydrogen bonding dominates the intermolecular bonding in the water lattice. In contrast, two alcohols have fewer hydrogen bonding sites as well as dispersion forces due to the non-polar carbon chains. The longer chain in ethanol may be responsible for the better quantification relative to methanol due to the increased contribution of non-hydrogen bonding to the viscoelastic properties.

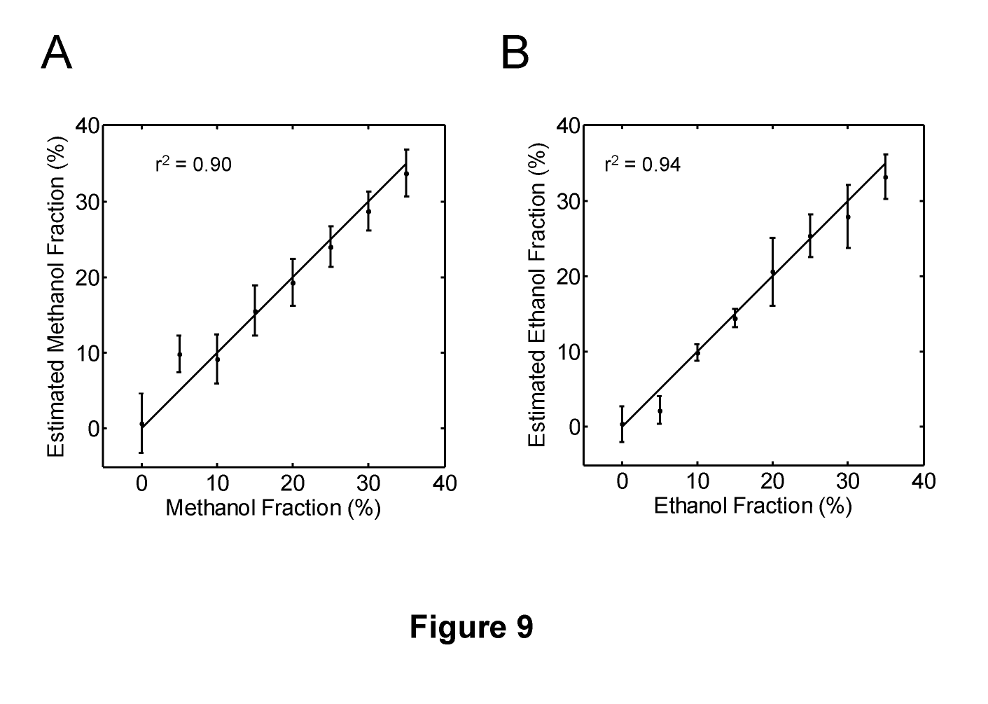

In order to increase the sensitivity of the methanol and ethanol analyses, the range of water volume fractions analyzed using the multilinear regression algorithm was narrowed. As demonstrated in FIG. 8, the viscoelastic apex present in velocity measurements (velocity increases to a maximum and then decreases) is also a factor in ultrasonic frequency propagation. Ultrasonic spectra from samples with a water content of 60-100% were analyzed separately. The result of this focused range was a significantly better estimation for methanol and ethanol volume fractions. The estimated volume fractions for both methanol and ethanol are shown in FIG. 9, which illustrates a greater linearity over the focused range. The standard error for the estimation for methanol was decreased from 16.2% to 3.7%=0.90). Ethanol estimates also showed a decrease in error, which was lowered from 11.5% to 2.9% (r²=0.94).

While narrowing the volume fractions analyzed limits quantification using a single model, many applications focus on a smaller, restricted range of concentrations. There is a strong potential to further decrease the error of estimation using iterative regression algorithms, which could potentially increase sensitivity and extend the range of analysis.

TABLE 2
Hydrogen bond lengths for homo- and hetero-dimers of water, methanol
and ethanol.

| | W | M | E |
|---|---|---|---|
| W | 2.918 | 2.844 | 2.843 |
| M | 2.912 | 2.846 | 2.888 |
| E | 2.914 | 2.853 | 2.850 |

If one interprets experimental data from a 2 component mixture, the change in ultrasound propagation velocity at different temperatures can be correlated to fractional composition of components and thus, the components can be determined. However, when interpreting a 3-component mixture, one needs to identify an additional parameter that can be provided by multivariate analysis of the spectral profile. Such a 3-component determination would not be possible using only the effect of temperature on propagation velocity for example.

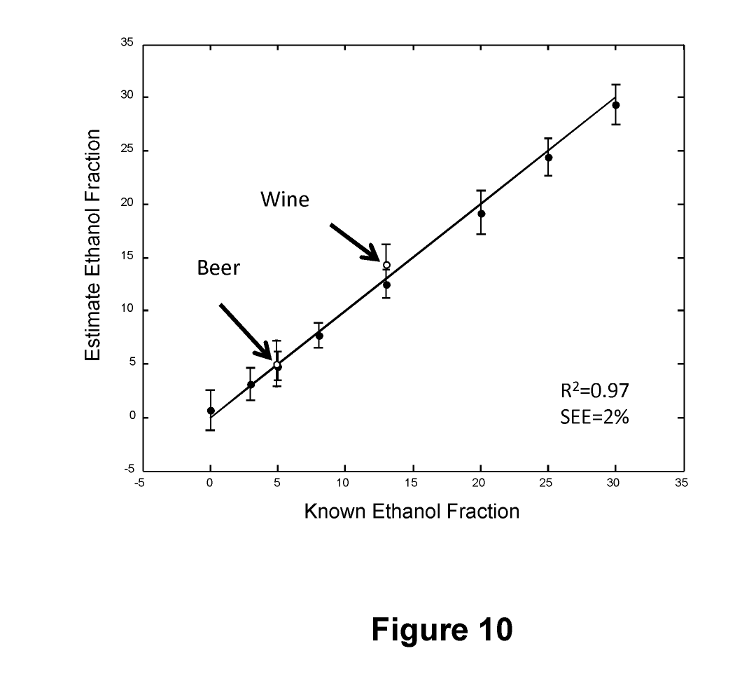

FIG. 10 shows the quantification of ethanol volume fraction. Known concentrations of ethanol are correlated with values estimated by multilinear regression (full circles). Estimates of wine and beer are also shown (unfilled circles), demonstrating that the multilinear model is applicable to real samples of alcoholic beverages. Interestingly, alcohol content could not be unambiguously determined using velocity in the 3-component mixture shown in table 3 and FIG. 10.

TABLE 3
Fractional composition of ethanol in a multi-component mixtures of
alcoholic beverages.

| | | Glucose | Velocity |
|---|---|---|---|
| | EtOH % | g/mL | m/s |
| Light Beer | 4.9 | 0.010 | 1486 |
| Red Wine | 13 | 0.025 | 1541 |

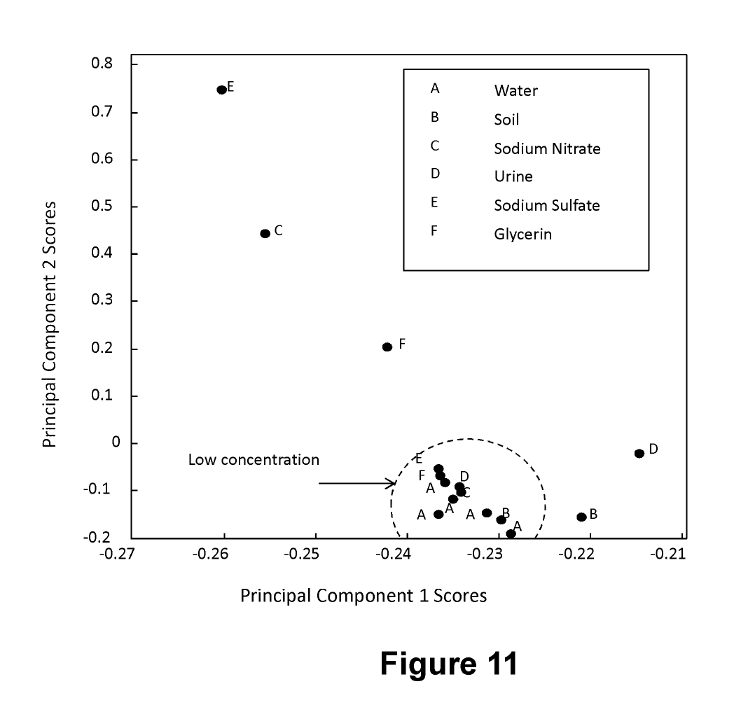

FIG. 11 shows selected water contaminants at low (inside the dashed circle) and high concentrations (outside the dashed circle). Correlation between the first and second component scores are determined by singular value decomposition. High concentrations of contaminants fall outside the values of the two scores in the dashed circle containing pure water and samples with levels of contaminants below their detection limits.

In some instances, a device capable of binary discrimination (i.e. under or over a predetermined threshold value or concentration of contaminant), according to the present invention finds useful applications in the environmental sector where specific thresholds of acceptable water “contaminants” are well defined. In some embodiments of the present invention, the device can be preset to signal only when a specific threshold has been surpassed, thus alarming operators that water quality is suboptimal and/or action is required. It will be appreciated that such a device would be linked (wired or wireless) to the control system (dashboard) of the water or wastewater plant for example. It will be appreciated that when a binary system according to the present invention is used the “fractional composition” can be binary such as “0 or 1”, “acceptable or unacceptable”, “above or below a threshold”, “on or off”.

Table 4 shows low and high concentrations of various water contaminants to highlight the binary discriminatory potential of this invention. The concentrations of contaminants shown in Table 4 are those plotted in FIG. 11.

Concentration

| Contaminant | [Low] | [High] |
|---|---|---|
| Soil | Slight color | Opaque |
| Sodium Nitrate | 0.02M | 1.17M |
| Urine | 10% (v/v) | 100% (v/v) |
| Sodium Sulfate | 0.07M | 0.70M |
| Glycerin | 1% (v/v) | 10% (v/v) |

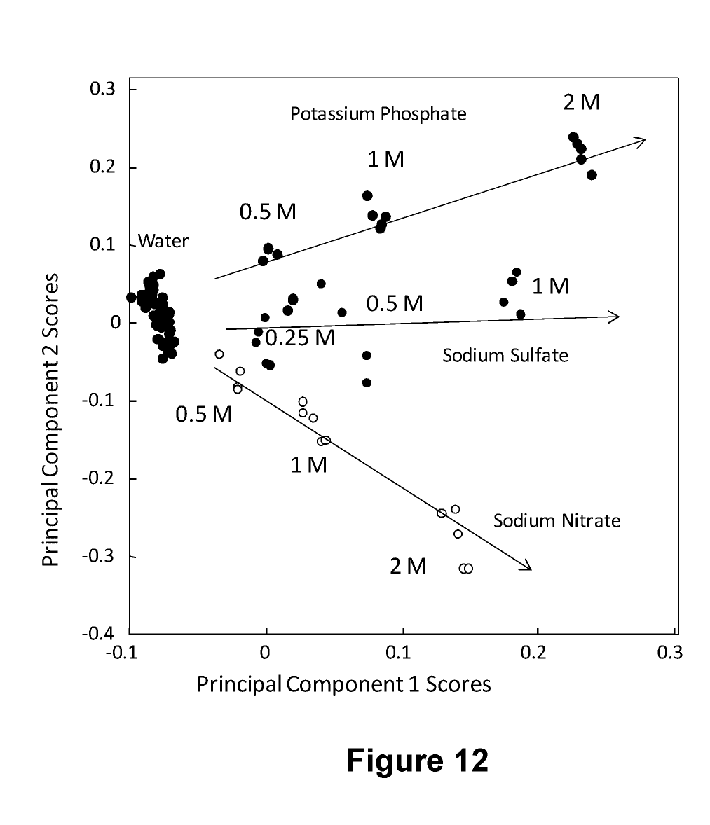

FIG. 12 shows the correlation between the first and second component scores in samples that contained increasing concentrations of water contaminants. This illustrates that the identity of the three contaminants (nitrate, sulfate, and phosphate) can be determined based on these two components, and that the concentration can likewise be determined. The principal components referred to in these figures are underlying components in the data that are determined using the singular value decomposition algorithm mentioned. The scores are representative weightings for the components that are determined for each spectrum. It will be appreciated that discriminatory potential in FIG. 12 is more than binary, as shown in FIG. 11.

Indeed, for the three contaminants shown (potassium phosphate, sodium sulphate and sodium nitrate), it was possible to determine a “fractional composition” using the two principal component scores. It will be appreciated by those skilled in the art that the contaminants studied are salts. In many cases, the actual “contaminant” is the phosphate, sulphate or nitrate groups of the various salts.

FIG. 13 depicts a portable ultrasonic device for determining fractional compositions in multi-component mixtures. This embodiment, as opposed to the lab scale embodiment of FIG. 3, is designed to be portable and handheld and therefore has the minimal essential elements. The dashed line is a scattering boundary such a conduit wall or a tissue such as skin. The device need not necessarily be designed to pass through a highly scattering boundary as, in some cases, it may be inserted directly into a fluid or a sample cell can be in direct “line-of-sight” contact with ultrasonic transducer. It will be appreciated that a source of electrical energy is not shown for simplicity. It will also be appreciated that the scattering boundary of FIG. 13 can be any boundary across which ultrasonic waves can traverse without losing their discriminatory potential. These boundaries also include but are not limited to synthetic materials, plastics, polymers, glass, various metals, alloys, textiles, carbon.

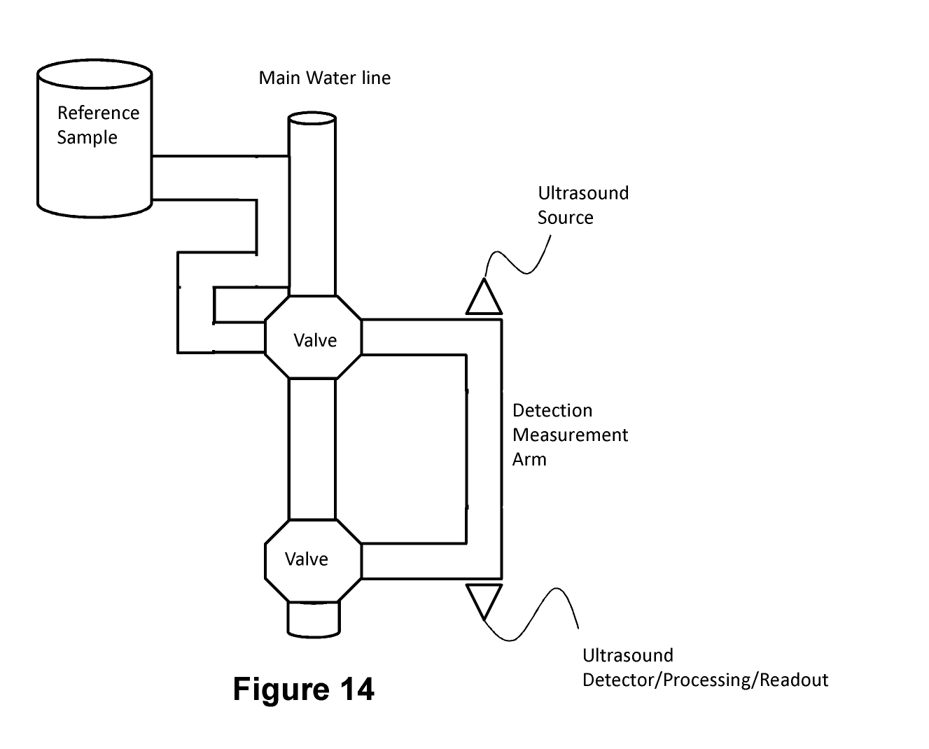

FIG. 14 shows an embodiment for use in industrial processes where fluid quality and/or composition is important. Such a system uses a reference sample to compensate for drifts in the detection system. For measurement of fractional composition of components using ultrasonic waves, a switchable valve would be used where either the water under investigation or a reference water sample could be introduced into a detection arm for the ultrasound measurements. Periodically, the valve would switch between the two water samples and the differences used in the non-linear ultrasonic profile used for determination of interference. One major source of drift in the instrument could be temperature. To compensate for variable temperature, the tube of the reference sample would be made to be in contact with the main water stream and would equilibrate with the temperature of the main water stream through heat exchange at the interface of the two fluids. Analysis of difference signals between the temperature compensated reference sample and the main water sample could then be made. In operation, the three way valve shown in FIG. 14 would be periodically switched to have the reference sample pass through the detection arm.

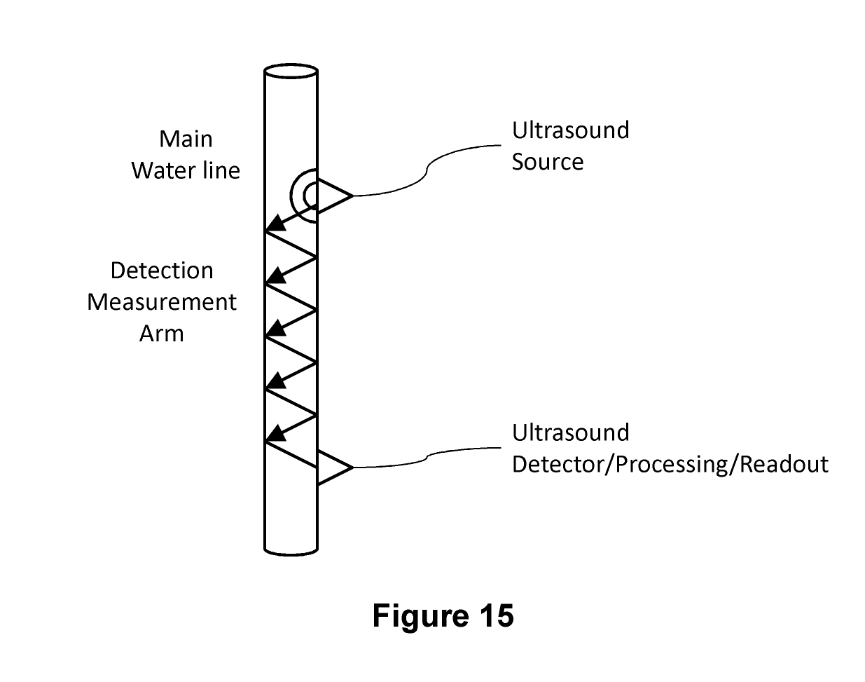

In addition to measurements made by transmission through a sample, non-linear ultrasonic measurements can also me made using a waveguide approach through a scattering boundary. This also provides a means for measurements to be made on the same side of a sample as shown in FIG. 15. One important advantage of this technology is that fractional compositions can be determined through a pipe or conduit due to the properties of ultrasounds. Such determinations across solid boundaries are very useful for industries such as water treatment and wastewater, brewing, etc. This type of device or method can be useful in cases where a conduit is of large diameter and underground, such as a main conduit in the aqueduct system. With this approach, one would only need access to one side of the large conduit. It will be appreciated that although the main industries cited as examples in this application are water, wastewater and brewing, any industry where multicomponent fluids need to be probed is interesting. One obvious example is the oil industry where pipelines are a main means of transport of the petrochemical fluid.

For the waveguide measurements in a pipe as an example, a source transducer would be placed in contact with the pipe and the ultrasound signal would be transmitted. After traversing the width of the pipe, the ultrasound would be reflected by the surface back to the initial side. This would be repeated many times. An ultrasound detector placed some distance down the pipe and on the same side would measure a transmission of the ultrasound which has undergone multiple reflections along with non-linear propagation through the waveguide media. Analysis of the resultant signal would then be similar to those measurements made for only one traverse through the sample.

Although the present application involves and describes only detecting intensities in the Time domain, it will be understood by those skilled in the art that using a Frequency domain would nevertheless be operative. It will also be appreciated that the spectral profile can be obtained in many ways. A spectral scan can be performed or, alternatively, several discrete frequencies can be selected when these frequencies are known.

Furthermore, because hydrogen bonding between the various components is responsible for non-linear variations observed in the spectral data, it will be understood that any component which can affect a mixture of components through hydrogen bonding could be detected by this approach. Post-translation modification of proteins is a good example. Although many types of post-translational modifications such as glycosylation, phosphorylation and palmitoylation can induce conformational changes to proteins which can be detected by ultrasounds (see co-pending application Pub. No. WO/2010/015073 for the effect of pH on protein conformation) some covalent modifications, such as hydroxylation and others can alter hydrogen bonding of the protein (due to the OH group) with its surroundings, thereby affecting non-linear propagation of ultrasonic waves in the mixture. Many industrial and biological process, such as fermentation, are effected by or rely on oxidative modifications.

What is claimed is:

1. A method of determining a fractional composition of a component in a multi-component mixture using multi-linear regression analysis of the ultrasonic spectral profile propagating through said mixture.

2. The method of claim 1, wherein fundamental physical properties of chemicals such as non-linear reaction of said chemicals to high-frequency oscillating pressure fields are used for determining said fractional composition.

3. The method of claim 1 or 2, wherein said determining a fractional composition comprises:
pulsing said mixture with a source of ultrasounds;
detecting ultrasonic spectral data propagating through said mixture;
computing said fractional composition of said component.

4. The method of claim 2, wherein said non-linear properties result from hydrogen bonding between components of a multi-component mixture.

5. The method of claim 3, wherein said computing fractional composition of said component comprises establishing a relationship between spectral frequency data and fractional composition of said component.

6. The method of claim 5, wherein said relationship is established using statistical analysis to identify one or more frequencies selected to reduce an error in fractional composition estimation when using said frequencies for calculating fractional composition.

7. The method of claim 6, wherein said statistical analysis comprises step-wise multi-linear regression.

8. The method of any one of claims 1 to 7, wherein said spectral profile is computed from intensity and frequency using a Fourier transform of the time domain.

9. The method of claim 3, wherein said ultrasonic probing consists of a pulsing ultrasound frequency of approximately 5 MHz.

10. The method of any one of claims 1 to 9, wherein said spectral profile is collected for a frequency range between 0.5 and 10 MHz.

11. The method of any one of claims 1 to 10, wherein said multi-component mixture comprises two components.

12. The method of any one of claims 1 to 10, wherein said multi-component mixture comprises three components.

13. The method of claim 11 or 12, wherein said component is one of water, ethanol and methanol.

14. The method of any one of claims 1 to 13, wherein said mixture is an alcoholic beverage.

15. The method of any one of claims 1 to 14, wherein said mixture comprises water and said component is a contaminant.

16. The method of claim 15, wherein said contaminant is one of soil, nitrates, urine, sulphates, phosphates and glycerine.

17. The method of claim 3, further comprising the step of securing the ultrasound apparatus of claim 27 to one side of a scattering boundary for determining said fractional composition of a mixture on another side of said scattering boundary.

18. The method of claim 17, wherein said scattering boundary is one of human tissue and a fluid conduit wall.

19. The method of any one of claims 1 to 18, wherein said mixture comprises water.

20. The method of any one of claims 1 to 18, wherein said component is glucose.

21. The method of any one of claims 1 to 20, wherein said mixture comprises at least one of blood, cerebral-spinal fluid, cell culture media and amniotic fluid.

22. The method of claim 3, further comprising signalling when a predetermined concentration of component is reached.

23. A method of calibrating a device for determining a fractional composition of a component in a multi-component mixture comprising:
probing a reference fluid with an ultrasound pulse;
detecting ultrasonic spectral data resulting from said pulse;
repeating the steps of said probing and said detecting using reference fluids of different fractional compositions of said component;
identifying frequencies at which signal intensity varies with fractional composition of said fluid component; and
adjusting said device to detect at least said frequencies.

24. The method of claim 23, further comprising limiting a concentration range of a reference fluids to a range where the correlation between estimated and actual fractional composition is highest.

25. The method of claim 24, where the concentration range for ethanol and methanol is limited to 0-35% fractional composition.

26. The method of claim 23, further comprising passing said reference fluid in close proximity with said multi-component mixture to favour heat exchange such that temperature of said reference fluid equilibrates to a temperature of said multi-component mixture.

27. An apparatus for determining a fractional composition of a component in a multi-component mixture using ultrasounds, wherein said apparatus is configured to perform the method of any one of claims 1 to 26.

28. The apparatus of claim 27, further comprising a securing mechanism for securing ultrasound instrumentation to the outside of a conduit.

29. The apparatus of claim 28, wherein a securing mechanism is one of a clip, a screw-based fastener, a magnet and a tie-wrap.

30. The apparatus of any one of claims 27 to 29, further comprising a detector circuit having one or more narrow band frequency filters.

31. The apparatus of any one of claims 27 to 30, further comprising a piezoelectric crystal transducer.

32. The apparatus of any one of claims 27 to 31, wherein all parts are located inside a portable handheld device.

33. The apparatus of any one of claims 27 to 32, wherein said component is a blood constituent.

34. An apparatus using ultrasound to determine the fractional composition of a component in a multi-component mixture comprising:
at least one ultrasonic transducer for generating and detecting an ultrasonic pulse;
a pulse generator for sending an input signal to said at least one transducer;
a detector circuit connected to said at least one transducer for providing an output signal; and
a processor for determining a fractional composition value using said output signal.
